(19) United States
(12) Patent Application Publication
(10) Pub. No.: US 2011/0129189 A1
(43) Pub. Date: Jun. 2, 2011

(54) CLAD METAL SUBSTRATES IN OPTICAL PACKAGES

(76) Inventors: Venkata Adiseshaiah Bhagavatula, Big Flats, NY (US); Satish Chandra Chaparala, Painted Post, NY (US); John Himmelreich, Horseheads, NY (US); Lawrence Charles Hughes, JR., Corning, NY (US)

(21) Appl. No.: 12/627,762

(22) Filed: Nov. 30, 2009

(51) Int. Cl. G02B 6/36

(52) U.S. Cl. 385/88

(57) ABSTRACT

Embodiments of the present disclosure bring a wavelength conversion device into close proximity with a laser source to eliminate the need for coupling optics, reduce the number of package components, and reduce package volume. According to one embodiment of the present disclosure, an optical package is provided comprising a laser diode chip and a clad metal substrate. The clad metal substrate comprises a clad metal region that is mechanically coupled to a base metal region. The laser diode chip is coupled to the clad metal region. The clad metal region comprises a clad metal material having a thermal conductivity that is greater than a thermal conductivity of the base metal material. The clad metal region further comprises a coefficient of thermal expansion that is approximately equal to a coefficient of thermal expansion of the base metal material and is greater than a coefficient of thermal expansion of the laser diode chip.

### CROSS-REFERENCE TO RELATED APPLICATIONS

This application is related to U.S. patent application Ser. No. 12/471,681 filed May 26, 2009 and to U.S. patent application Ser. No. 12/471,666, filed May 26, 2009, but does not claim priority thereto.

### BACKGROUND

The present disclosure relates to frequency-converted laser sources, laser projection systems and, more particularly, to optical packaging configurations for laser sources and multi-color laser projectors in applications such as cell phones, PDAs, laptop computers, etc.

### BRIEF SUMMARY

The present inventors have recognized that frequency-converted laser sources and multi-color laser projectors must be compact to be feasible for many projection applications. This object is particularly challenging in multi-color projection systems requiring three independent color sources (red, green, blue). Although red and blue sources are reasonably compact, frequency-converted green laser sources present a particular challenge in this respect because they commonly utilize an IR laser source and a second harmonic generation (SHG) crystal or some other type of wavelength conversion device. Active or passive coupling optics are often utilized to ensure proper alignment of the IR pump light with the waveguide of the SHG crystal. The package may also include hardware for enhancing mechanical stability over a wide temperature range. Together, these components increase overall package volume and operational complexity.

Particular embodiments of the present disclosure bring the SHG crystal, or other type of wavelength conversion device, into close proximity with the laser source to eliminate the need for coupling optics, reduce the number of package components, and reduce package volume. According to one embodiment of the present disclosure, an optical package is provided comprising a laser diode chip and a clad metal substrate. The clad metal substrate comprises a clad metal region that is mechanically coupled to a base metal region. The laser diode chip is mechanically coupled to the clad metal region. The clad metal region comprises a clad metal material having a thermal conductivity that is greater than a thermal conductivity of the base metal material. Additionally, the clad metal region comprises a coefficient of thermal expansion that is approximately equal to a coefficient of thermal expansion of the base metal material and is also greater than a coefficient of thermal expansion of the laser diode chip. Additional embodiments are disclosed and contemplated. For example, it is contemplated that the concepts of the present disclosure will be applicable to any optical package comprising a source, laser or non-laser, and receiver, whether it be a wavelength conversion device or some other type of downstream optical component.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIGS. 1 and 2 illustrate a proximity-coupled optical package according to one embodiment;

FIGS. 3A and 3B are schematic plan views of further alternatives for providing a wavelength conversion device in an optical package similar to that illustrated in FIGS. 1 and 2;

FIGS. 4A-4D are schematic elevation views illustrating the manner in which a wavelength conversion device may be tilted vertically in an optical package similar to that illustrated in FIGS. 1 and 2;

FIGS. 5-8 illustrate an optical package comprising a laser source subassembly and an independent wavelength conversion device subassembly where edge bonding is facilitated via complementary bonding interfaces;

FIGS. 9-11 illustrate an optical package comprising a laser source subassembly and an independent wavelength conversion device subassembly where a common securement engages a peripheral abutment extending along the laser base and the converter base;

FIGS. 12-14 illustrate an optical package comprising a laser source subassembly and an independent wavelength conversion device subassembly where respective fixturing datums facilitate nesting of the laser base and the converter base; and

FIG. 15 is a schematic illustration of a manner for securing an optical package comprising a laser source subassembly and an independent wavelength conversion device subassembly.

### DETAILED DESCRIPTION

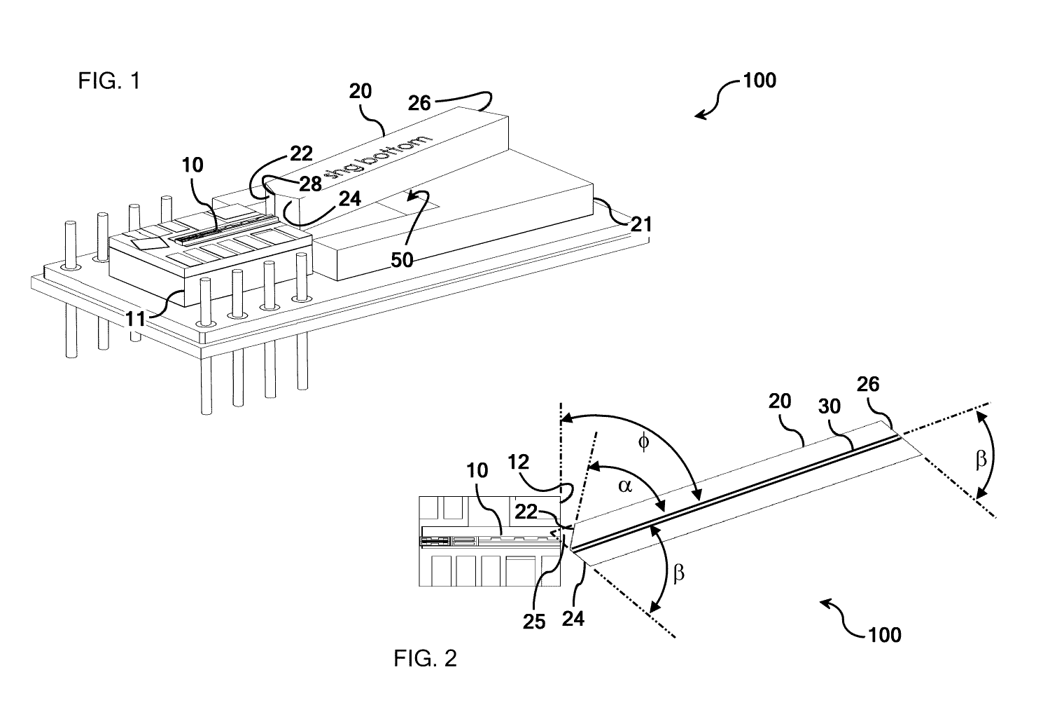

Referring initially to FIG. 1 and FIG. 2, an optical package 100 according to one embodiment of the present disclosure is illustrated. FIG. 1 illustrates an optical package 100 comprising a laser source 10 and a wavelength conversion device 20. The wavelength conversion device 20 comprises an input face formed of an α-cut facet 22 and β-cut facet 24, an output face 26, and a waveguide 30 extending from the input face to the output face 26. The laser source 10 is positioned such that an output face 12 of the laser source 10 is proximity-coupled to the waveguide portion of the input face of the wavelength conversion device 20.

For the purposes of describing and defining the present disclosure, it is noted that a laser source can be considered to be “proximity-coupled” to a wavelength conversion device when the proximity of the output face of the laser source and the input face of the wavelength conversion device is the primary mechanism for coupling an optical signal from the laser source into the waveguide of the wavelength conversion device. Typical proximity-coupled packages will not employ collimating, focusing, or other types of coupling optics in the optical path between the laser source and the wavelength conversion device, although it is contemplated that some proximity-coupled packages may employ relatively insignificant optical elements between the laser and wavelength conversion device, such as optical films, protective elements, correction lenses, optical filters, optical diffusers, etc. In any case, for proximity-coupled packages, it is contemplated that the proximity of the laser and the wavelength conversion device will be responsible for at least 30% of the optical intensity coupled from the laser to the wavelength conversion device.

FIG. 2, where like structure is indicated with like reference numerals, illustrates the input face of the wavelength conversion device 20 in greater detail. As is noted above, the input face of the wavelength conversion device comprises an α-cut facet 22 and β-cut facet 24. The α-cut facet 22 of the input face is oriented at a horizontal angle α, relative to the waveguide 30 of the wavelength conversion device 20 to permit proximity coupling of the output face 12 of the laser source 10 and the input face of the wavelength conversion device 20. The β-cut facet 24 of the input face is oriented at a horizontal angle β, relative to the waveguide 30 of the wavelength conversion device 20 and cooperates with the horizontal tilt angle φ to reduce back reflections from the input face of the wavelength conversion device 20 into the laser source 10, which are commonly caused by light being reflected from the input face of a waveguide back into the acceptance cone of the output face of a laser source.

To facilitate the aforementioned proximity coupling, the angle a and the angle β should be selected to satisfy the following relation:

α<180°−β<φ.

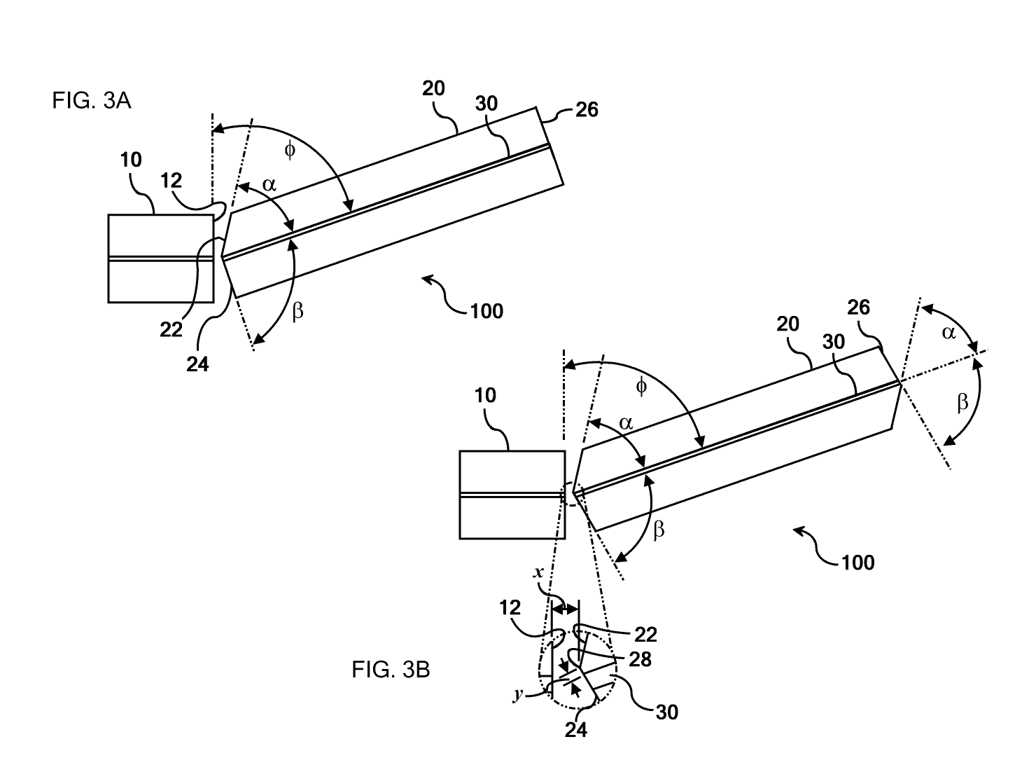

As is illustrated in FIGS. 2, 3A and 3B, where like structure is indicated with like reference numerals, and where the waveguide 30 is oriented at a horizontal tilt angle φ relative to the output face 12 of the laser source 10, to further enhance proximity coupling, the angle α of the α-cut facet 22 is typically established at a value that is less than the horizontal tilt angle φ, as measured along a common direction from the waveguide 30. Alternatively, it may merely be sufficient to ensure that the α-cut facet 22, the β-cut facet 24, or both are oriented at acute angles relative to the waveguide 30 of the wavelength conversion device 20, which, for the purposes of describing and defining the present disclosure, is an angle less than 90°. For example, and not by way of limitation, the horizontal tilt angle φ may fall between approximately 75° and approximately 85°, the angle α of the α-cut facet 22 may be about 10° to about 15° less than the horizontal tilt angle φ, and the angle β of the β-cut facet 24 may be about 80°.

Regardless of the particular angles selected for the angle α and the angle β, the α-cut facet 22 and the β-cut facet 24 will form an apex 28 on the input face. As is illustrated in FIG. 3B, the apex 28 is spaced from the waveguide portion of the input face, typically by a waveguide spacing y of less than approximately 20 μm. Further, the apex 28 is spaced from the output face 12 of the laser source 10 by an interfacial spacing x, which can be on the order of less than approximately 5 μm. Proximity coupling is facilitated in the illustrated embodiments because the relative sign and magnitude of the angles α and β yield a vacated body portion 25, which would otherwise be present in a wavelength conversion device not including the α-cut facet 22. In a proximity-coupled package, the vacated body portion 25, the bounds of which are illustrated with dashed lines in FIG. 2, breaches the output face 12 of the laser source 10 and illustrates the degree to which the α-cut facet 22 enhances proximity coupling. Stated differently, the α-cut facet 22 removes portions of the wavelength conversion device 20 that would otherwise present a physical obstruction to close proximity coupling. This removed portion is illustrated in FIG. 2 as the vacated body portion 25.

The laser source 10 is preferably proximity-coupled to the waveguide 30 portion of the wavelength conversion device 20 without the use of intervening optical components. For the purposes of describing and defining the present disclosure, it is noted that “intervening optical components” are those whose optical properties are not necessary to support the functionality of the laser source or the wavelength conversion device. For example, intervening optical components would include a collimating or focusing lens positioned in the optical path between the laser source and the wavelength conversion device but would not include anti-reflective or reflective coatings formed on the output face of the laser or on the input face of the wavelength conversion device.

In the embodiments of FIGS. 2 and 3A, the output face 26 of the wavelength conversion device is oriented to match the angle β of the β-cut facet 24. Alternatively, as is illustrated in FIG. 3B, it is contemplated that the output face 26 of the wavelength conversion device 20 may comprise an additional pair of facets that mirror the α-cut facet and the β-cut facet of the input face of the wavelength conversion device.

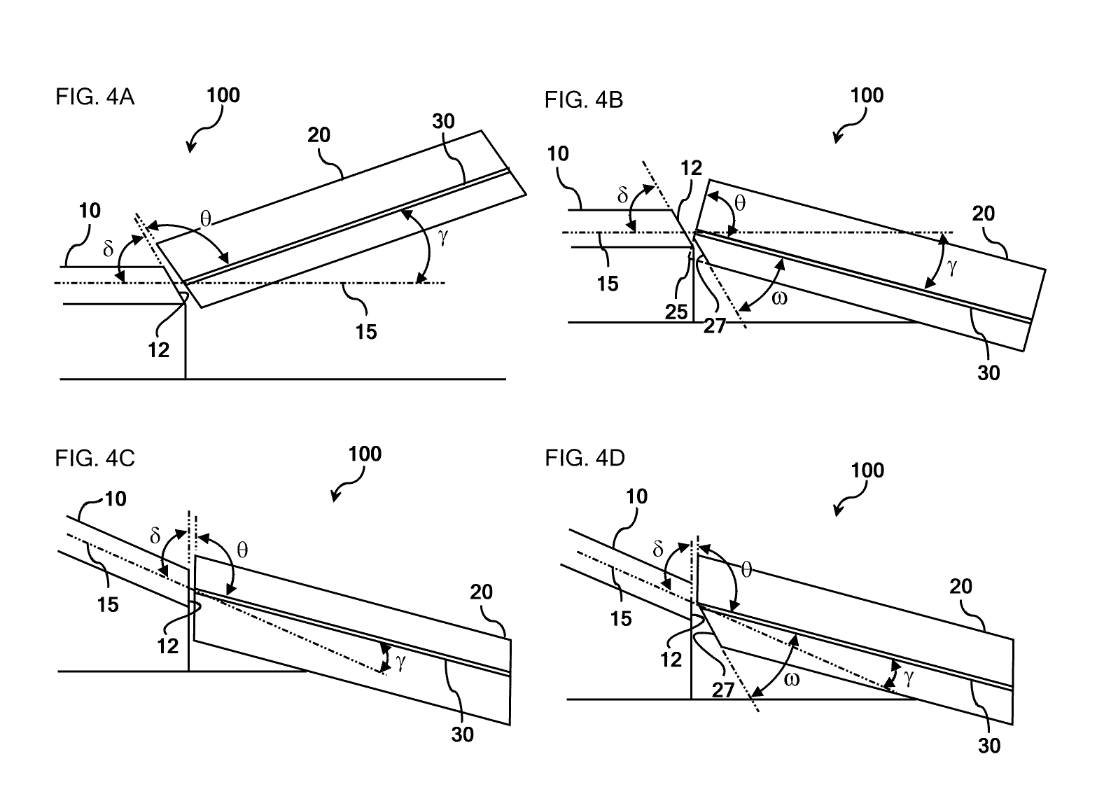

FIGS. 4A-4D are schematic elevation views illustrating the manner in which a wavelength conversion device 20 may be tilted vertically in an optical package 100 to complement the corresponding tilt of the output face 12 of the laser source 10. More specifically, referring collectively to FIGS. 4A-4D, in some applications, the output face 12 of the laser source 10 will be oriented at a vertical angle δ relative to the optical axis 15 of the laser source 10. This angle is typically on the order of a few degrees but has been exaggerated in FIGS. 4A-4D for illustrative purposes. Similarly, the input face of the wavelength conversion device 20 will be oriented at a vertical angle θ relative to the waveguide of the wavelength conversion device. The vertical angle θ typically exceeds 90° but can take a variety of values depending on the particular wavelength conversion device 20 selected for the optical package, including the orthogonal angle illustrated in FIG. 4B. The vertical angle θ of the input face and the vertical tilt angle γ of the wavelength conversion device 20, which is taken relative to the optical axis 15, are selected to at least partially compensate for optical misalignment introduced by the laser output face angle δ.

Referring to FIGS. 4B and 4D, to further facilitate proximity coupling in some embodiments, it may be preferable to provide the input face of the wavelength conversion device 20 with an ω-cut facet 29 oriented at a vertical angle ω, relative to the waveguide 30. The ω-cut facet 27 functions in a manner similar to the α-cut facet 22 of FIGS. 1-3 in that it removes portions of the wavelength conversion device 20 that would otherwise present a physical obstruction to close proximity coupling. See, for example, the vacated body portion 25 illustrated in FIG. 4B. Based on the tilts in the output face 12 of the laser source 10 and the corresponding angled facets polished into the input face of the wavelength conversion device 20, the substrates of the laser source 10 and the wavelength conversion device 20 can be tapered as shown in FIG. 4B and 4D. Such tapering of the substrates facilitates easier facet alignment during subassembly fabrication. With these suitably predetermined tapered angles, the proximity gaps can be minimized without damaging the output face 12 of the laser source 10 or the input face of the wavelength conversion device 20. In addition, the aforementioned tapering minimizes angular misalignment losses and provides better coupling efficiency.

To help preserve optimum optical coupling in proximity-coupled optical packages where the wavelength conversion device 20 and the laser source 10 are supported by independent stacks, the respective coefficients of thermal expansion of the independent stacks can be matched to account for thermal expansion of the respective stacks, which could otherwise cause losses in coupling efficiency between the laser source 10 and the wavelength conversion device 20 as the optical package is subjected to temperature excursions during normal operation. In many cases, it will not be difficult to a thermalize the proximity-coupled optical packages illustrated herein because the absence of coupling optics permit reduced stack heights, making it easier to match the respective coefficients of thermal expansion of the independent stacks.

For example, referring to FIG. 1, where the laser source 10 is supported by a laser stack 11 and the wavelength conversion device 20 is supported by a converter stack 21, the optical package 100 can be a thermalized by ensuring that the respective coefficients of thermal expansion of the two independent stacks 11, 21 are matched. For example, in one embodiment the coefficients of thermal expansion of the two independent stacks 11, 21 are matched to within approximately 0.01 μm over the operating temperature range of the optical package 100. For example, the laser stack 11 may comprise aluminum nitride, Au metallization pads and molybdenum and the converter stack 21 may comprise silicon. For the purposes of defining and describing the present disclosure, it is noted that a “stack” may comprise any number of layers. Additionally, it is contemplated that the degree to which the coefficients of thermal expansion are matched may be increased or decreased depending on the desired degree of coupling efficiency.

FIG. 1 also illustrates the use of an underlying thermal void 50 to mitigate thermal gradients that develop within the wavelength conversion device 20 during operation of the optical package 100. Because the laser source 10 is proximity-coupled to the wavelength conversion device 20, significant thermal gradients can be induced along the length of the wavelength conversion device 20 due to a difference in temperature between the input face and the output face 26 of the wavelength conversion device 20, particularly when the optical package 100 is passively cooled, for example by natural convection. These thermal gradients can decrease the efficiency of the wavelength conversion device 20 by shifting the phase matching wavelength beyond the spectral width of the fundamental laser light. As is illustrated in FIG. 1, the underlying thermal void 50 can be provided in the vicinity of the input face of the wavelength conversion device 20 to help thermally isolate the input end of the wavelength conversion device 20 and reduce operational thermal gradients along the wavelength conversion device 20.

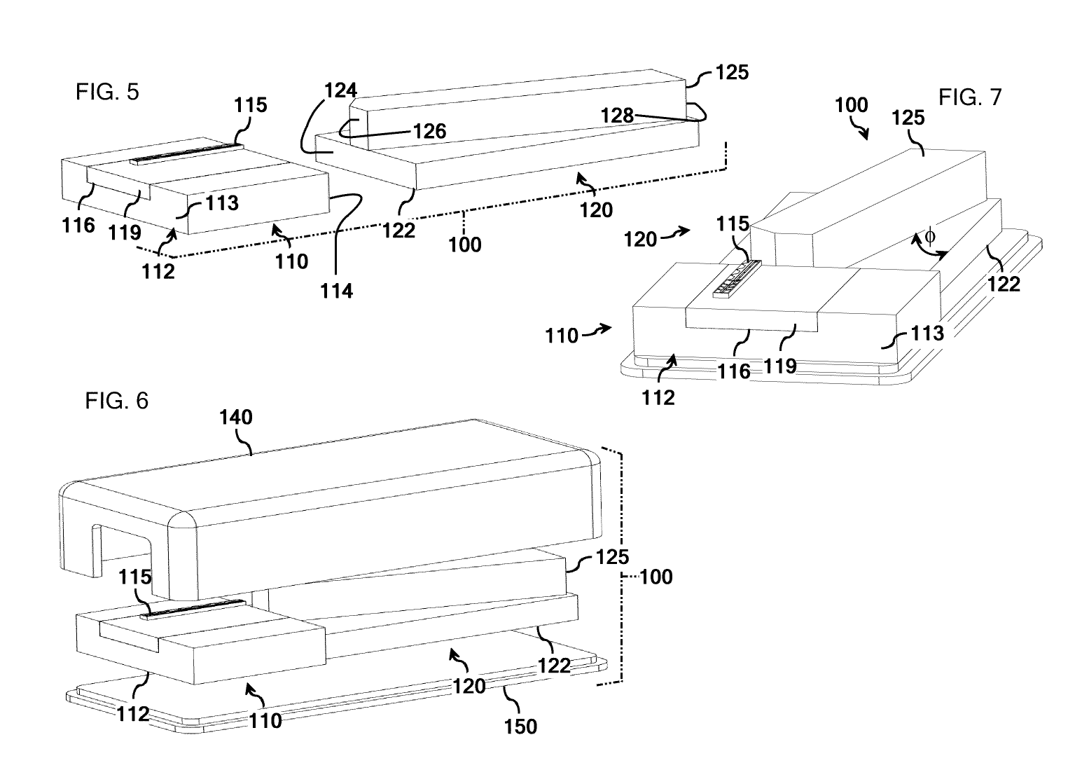

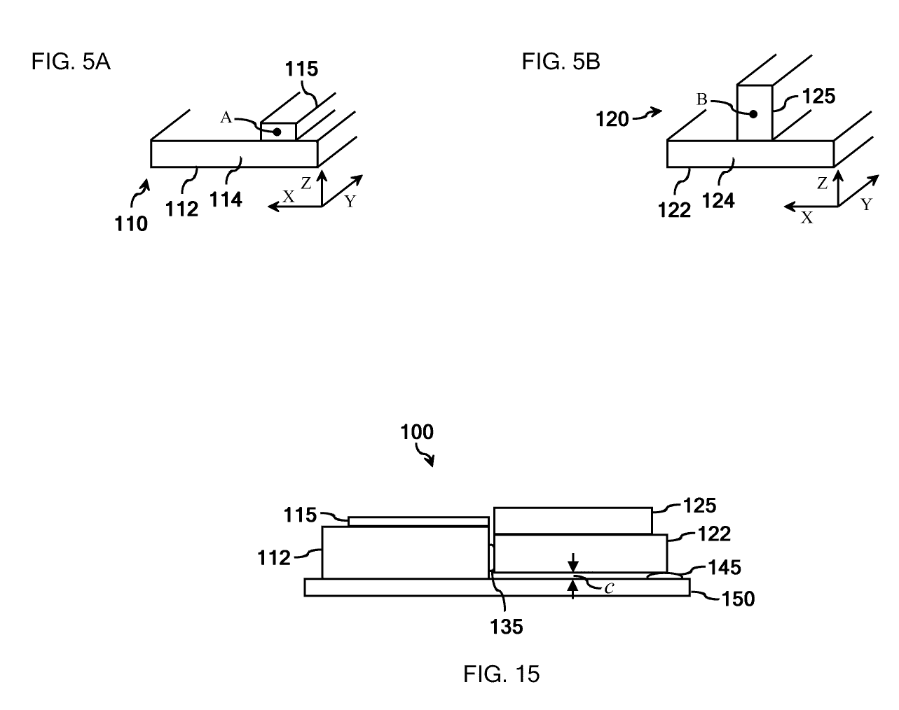

FIGS. 5-7 illustrate an optical package 100 comprising a laser source subassembly 110 and an independent wavelength conversion device subassembly 120 where proximity-coupled edge bonding is facilitated via complementary bonding interfaces. More specifically, in the embodiment of FIGS. 5-7, the laser source subassembly comprises a laser base 112 including a bonding interface 114, and a laser diode 115. The laser diode 115 is secured to the laser base 112 such that a set position A of the laser output face is fixed in an X-Y-Z coordinate system relative to the bonding interface 114 (see FIG. 5A). It is contemplated that the laser diode 115 can be secured to the laser base 112 in a variety of ways including, for example, through adhesive bonding (UV heat epoxy), soldering, laser welding, mechanical securement, etc.

Similarly, the wavelength conversion device subassembly 120 comprises a converter base 122 including a complementary bonding interface 124, and a wavelength conversion device 125 including a converter input face 126, a converter output face 128, and a waveguide extending from the converter input face 126 to the converter output face 128 at a conversion device tilt angle φ. The wavelength conversion device 125 is secured to the converter base 122 such that a set position B of the converter input face 126 and the tilt angle φ of the waveguide are fixed in an X-Y-Z coordinate system relative to the complementary bonding interface 124 (see FIG. 5B). It is contemplated that the wavelength conversion device 125 can be secured to the converter base 122 in a variety of ways including, for example, through adhesive bonding (UV heat epoxy), soldering, laser welding, mechanical securement, etc.

The laser diode 115 and the wavelength conversion device 125 are mounted to their respective bases 112, 122 in a preassembly process that is controlled precisely to establish the set positions A and B in predetermined locations. Given properly established set positions A and B, the bonding interface 114 of the laser base 112 can be bonded to the complementary bonding interface 124 of the converter base 122 to proximity couple the laser output face to the converter input face 126 at an orientation and interfacial spacing x that is suitable for a proximity coupled package. In general, the advantages of the designs disclosed herein where fixturing datums are employed to engage and align respective sub-assemblies to each other, measurement of the interfacial spacing x during final assembly is no longer critical because the laser source and conversion device sub-assemblies are put together with required accuracy separately and characterized before final assembly.

Although in one embodiment, the converter base 122 and the laser base 112 are substrates formed from a common metal, it is contemplated that the converter base 122 and the laser base 112 can be fabricated from any materials with approximately equivalent coefficients of thermal expansion or can be designed for approximately equivalent thermal expansion properties. In this manner, when the respective subassemblies are bonded via the respective bonding interfaces 114, 124, any thermally induced misalignment of the converter input face 126 and the laser output face that could arise from thermal expansion in the converter base 122 and the laser base 112 can be minimized and would typically be less than 0.1-0.5 μm over the operating temperature range of the optical package 100.

In FIGS. 5-7, the respective bonding interfaces 114, 124 can be described as complementary fixturing datums because, when they are urged against each other prior to bonding, their mutual engagement establishes the interfacial spacing x at the aforementioned predetermined value. The nature of the interfaces 114, 124 is such that the interfacial spacing is fixed but movement along other directions, i.e., in a plane parallel to the interfaces 114, 124, is permitted. Having noted this, it is contemplated that the complementary fixturing datums defined by the bonding interfaces 114, 124 could be modified to limit movement in more than one direction.

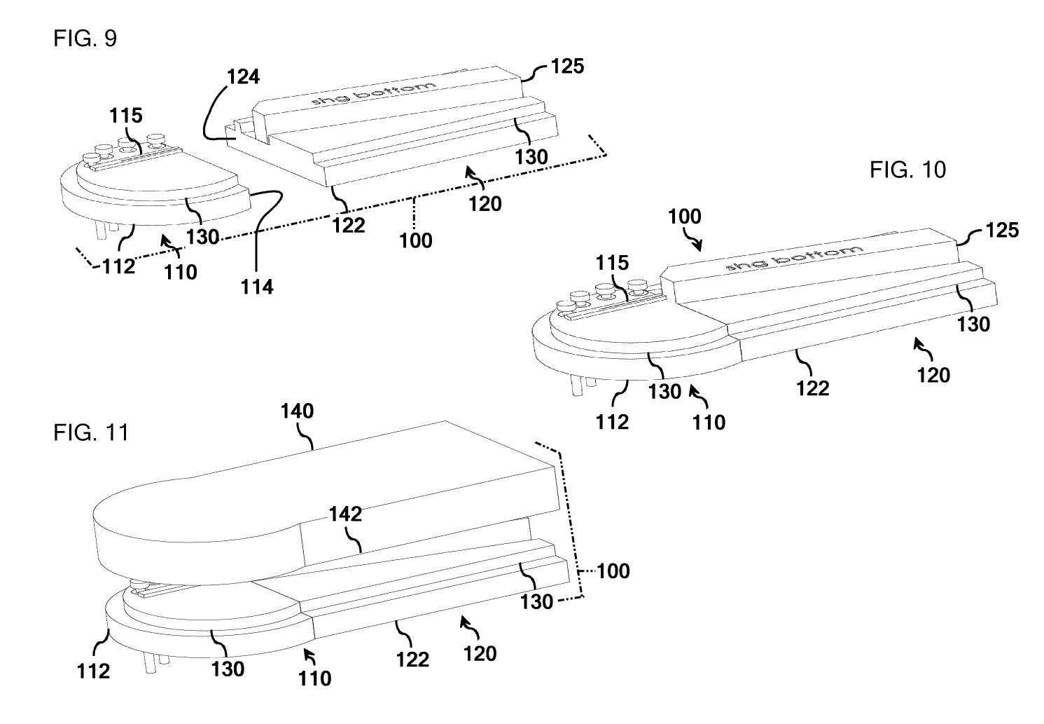

For example, referring to the embodiment of FIGS. 9-11, the complementary fixturing datums defined by the complementary bonding interfaces 114, 124 can be configured for engagement via a common securement to enhance fixation of the laser source subassembly 110 and the wavelength conversion device subassembly 120 in a three dimensional orthogonal coordinate system. More specifically, in the embodiment of FIGS. 9-11, the complementary fixturing datums comprise planar bonding interfaces (bonding interfaces 114, 124) and a step-shaped peripheral abutment 130 that extends along the periphery of the laser base 112 and the converter base 122. A rigid package cover 140 is provided as the common securement and a lower edge portion 142 of the rigid package cover 140 engages the peripheral abutment 130 to secure the respective subassemblies 110, 120 to each other and limit movement of the laser diode 115 relative to the wavelength conversion device 125 in more than one direction. It is contemplated that a variety of alternative devices could alternatively be employed as the common securement.

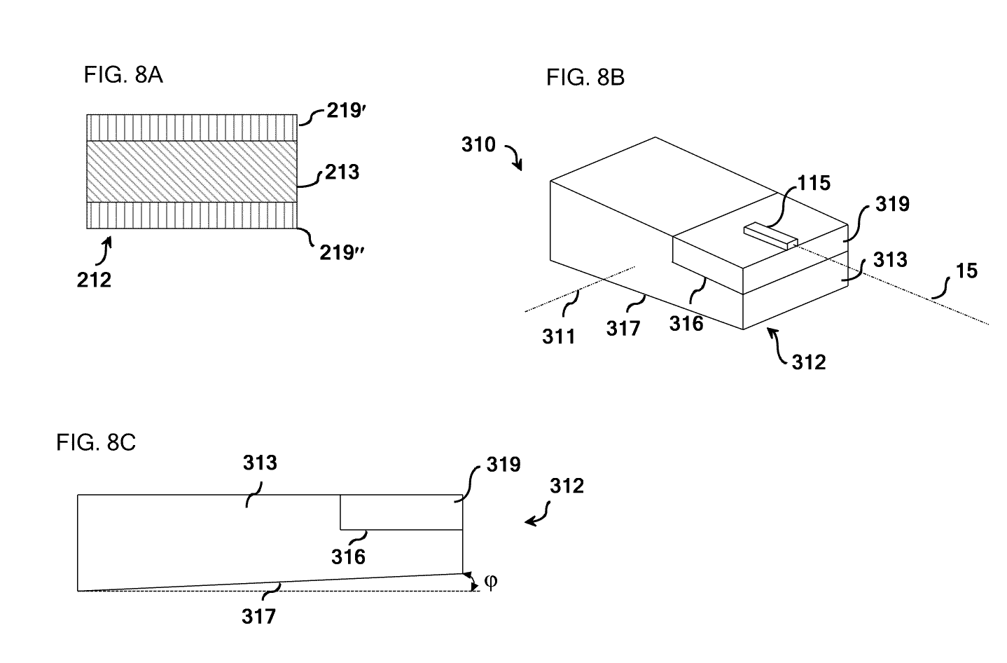

FIGS. 5-8B also illustrate the use of a laser base 112 configured as a clad metal substrate that comprises a base metal region 113 formed of a base metal material and a clad metal region 119 formed of a clad metal material. The laser diode 115 is secured to the clad metal region 119. The clad metal region 119 may be secured within a laser mounting slot 116 of the base metal region 113 that extends from a first face (e.g., bonding interface 114) to an opposite second face of the base metal region 113 as illustrated in FIGS. 5-7. A clad metal material is defined as a metal material that is tightly press-fitted into the laser mounting slot 116 such that minimal spacing exists between the clad metal region 119 and the base metal region 113. For example, a clad metal region 119 in a base metal region 113 may be cold rolled together in long lengths during a cladding process and cut to required lengths and shapes to make low cost laser bases. Use of a cladding process also eliminates the need for adhesives to mechanically couple the clad metal region to the base metal region. Other clad metal substrate configurations for the laser base are also possible. For example, FIG. 8A illustrates a front face view of an exemplary a laser base 212 that comprises an upper clad metal layer 219′ and a lower clad metal layer 219″ positioned above and below a base metal region 213, which is configured as a base metal layer. A cladding process may also be used to mechanically couple the upper and lower clad metal layers 219′, 219″ to the base metal region 213.

FIGS. 8B and 8C illustrate another embodiment of a laser base 312 that is configured as a clad metal substrate having a tapered base metal region 313 that defines a mounting slot 316 configured as seat on a laser diode end of the base metal region 313 in which a clad metal region 319 may be positioned. The clad metal region 319 may be secured within the mounting slot 316 by a cladding process, and the laser diode 115 may be secured to the clad region 319 as described above. As depicted in FIG. 8C, the bottom surface 317 of the base metal region 313 may be tapered at laser base taper angle φ to achieve various facet alignment configurations as described above with reference to FIGS. 4C and 4D. For example, the tapered bottom surface 317 of the base metal region 313 may downwardly tilt the optical axis 15 of the laser diode 115 by the laser base taper angle φ. The tapered laser base 312 may be fabricated by introducing the laser base taper angle φ during an extrusion process as the laser base 312 is extruded in an extrusion direction 311. The extruded structure may then be then be cut into pieces to create a plurality of laser bases.

The clad metal region is configured to improve heat management and a thermalization in the optical package. The thermal expansion characteristics of the clad metal region are chosen to minimize the tensile forces in the laser diode chips over the temperature range of interest. For example, a material may be chosen for the clad metal region that has a coefficient of thermal expansion that is slightly greater than the coefficient of thermal expansion of the laser diode. The clad metal region may therefore put the laser diode in compression rather than tension in the presence of elevated temperatures, which is defined as temperatures during and/or after the laser diode is soldered to the clad metal region, as well as temperatures during optical package operation. Putting the laser diode in compression may minimize the potential for chip failures due to cracking.

Additionally, the clad metal region and base metal region material may be chosen such that the two regions have substantially the same or similar coefficients of thermal expansion. This may minimize the interfacial stresses between the clad metal and the base metal. The clad metal region can also be used for good then thermal conductivity (e.g., greater than 80 W/m-k) to distribute and dissipate the heat generated by the laser diode. This aspect also provides the flexibility in choosing the base metal region material somewhat independently from the clad metal region material.

In one exemplary embodiment, a base metal region is made of stainless steel (e.g., 304L stainless steel) and the clad metal region is made of copper. A 1060 nm laser diode is coupled to the clad metal region via a eutectic Au—Sn solder. Other solders having a low coefficient of thermal expansion may also be used. Because copper has very high thermal conductivity, it may provide excellent heat dissipation that provides better thermal management of the laser diode both during operation of the optical package and during the soldering of the laser diode to the clad metal region. The stainless steel material is lower cost and can be more easily bonded to the converter assembly by laser welding. Other materials may be used interchangeably for either the base metal region or the clad metal region depending on the design requirements of the optical package. For example, other clad metal region materials may include, but are not limited to, molybdenum, aluminum and brass. These clad metal region materials may be used in conjunction with other base metal region materials that include, but are not limited to, bronze, 304 stainless steel, and 410 stainless steel.

Referring to the embodiment of FIGS. 6 and 7, the laser base 112 may be bonded to the converter base 122 at complementary bonding interfaces 114, 124 by laser welding. The materials chosen for the base metal region 113 and the converter base 122 of this embodiment should be capable of being welded by a laser welding process. For example, stainless steel, such as 304L stainless steel, for example, has low carbon content that reduces corrosion near the weld location. Other materials such as steel, for example, may also be used for the base metal region and the converter base.

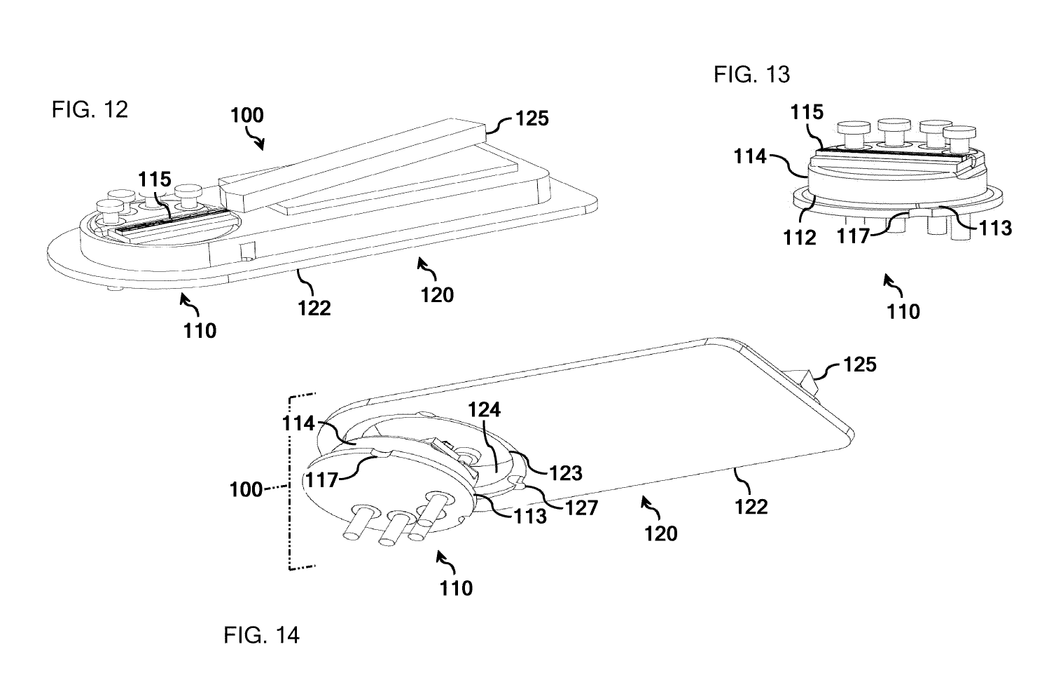

The embodiment of FIGS. 12-14, described in detail below, also utilizes a laser mounting slot and clad metal region to a thermalize the optical package 100. In the embodiment of FIGS. 12-14, the laser diode 115 is mounted on an insert that matches the coefficient of thermal expansion of the laser diode and the laser diode and insert together are mounted on a TO-can style header. The header can be low cost, cold-rolled steel provided with a cut-out for the insert. Finally, it is noted that FIGS. 6-7 illustrate the use of a rigid package cover 140 and a package base 150 for encapsulation.

In the embodiment of FIGS. 12-14, the laser source subassembly 110 and the wavelength conversion device subassembly 120 comprise complementary fixturing datums that are configured for mutual engagement in a nested configuration. More specifically, the fixturing datum of the converter base 122 comprises an inside diameter abutment 123, and the fixturing datum of the laser base 112 comprises an outside diameter abutment 113, both of which are configured to facilitate nesting of the laser base 112 within the converter base 122 via engagement of the respective abutments 113, 123. It is contemplated that the inside and outside diameters can be circular or non-circular.

Because the fixturing datums in the embodiment of FIGS. 12-14 permit engaged rotation of the nested laser base 112 relative to the converter base 122, it may be preferable to provide the laser base 112 and the converter base 122 with rotational fixturing datums that can be used as an indication of proper rotational alignment of the laser base 112 relative to the converter base 122. In FIGS. 12-14 rotational fixturing datums are provided as semi-circular cut-outs 117 in the laser base 112 and corresponding holes 127 formed in the converter base 122. Proper rotational alignment is achieved when the semi-circular cut-outs 117 in the laser base 112 are aligned with the corresponding holes 127 formed in the converter base 122. It is contemplated that a variety of combinations of holes, slots, indicators, etc., can be provided in the laser base 112 and converter base 122 to function as rotational fixturing datums.

Although the embodiments of FIGS. 5-13 are presented in the context of a wavelength conversion device 125 that is merely tilted in the horizontal plane, it is contemplated that vertical tilting or a combination of vertical and horizontal tilting may alternatively be employed in the illustrated embodiments. Similarly, the laser source subassembly 110 and the converter subassembly 120 may be presented in a variety of configurations and may include suitable mounting hardware, mounting slots, etc. Finally, it is noted that the input face of the wavelength conversion device 125 may include the α-cut, β-cut, and ω-cut facets described above with reference to FIGS. 1-4.

Referring to the schematic illustration of FIG. 15, it is noted that the laser base 112 can be bonded to the converter base 122 via an interfacial bond 135 that separates the laser output face and the converter input face by a spacing on the order of a few microns, i.e., less than 10 microns and more than a fraction of a micron. The laser base 112 is also bonded rigidly to the package base 150 for mechanical strength and also thermal management of the heat generated by the laser diode. On the other hand, the converter base 122 is rigidly bonded to the laser base only, but not to the package base 150. The converter base 122 can be secured to the package base 150 via a less rigid topographic securement 145 that forms a thermal excursion gap c between the conversion device subassembly and the package base 150. The topographic securement 145 may comprise an elastomeric adhesive or some other type of elastomeric component that is designed to yield to micron-level thermal excursions in the optical package 100. In this manner, the converter subassembly can be isolated from the package base 150 to avoid misalignment due to CTE mismatches in the optical package 100.

More specifically, in the embodiment of FIG. 15, only the laser base 112 is rigidly and intimately attached to the package base 150. This provides for low thermal impedance and a good heat dissipation path for the laser diode. The converter base 122 is secured to the package base 150 via, e.g., an elastomeric adhesive or other type of flexible bond, to form a thermal excursion gap c between the conversion device subassembly and the package base 150. For example, and not by way of limitation, the thermal excursion gap c can mitigate the effects of thermal excursions within the optical package 100 if it is less than approximately 100 μm, although larger gaps would also be effective. The criteria in choosing the gap is to relax the manufacturing and alignment tolerances of the substrates, while at the same time making sure that the converter base and the package base are not in intimate contact. With this gap, any thermal expansion mismatches between the package base and converter base are not transferred to the converter base and cause misalignment. Typically, it will be preferable to secure the converter base 122 to the laser base 112 via a more rigid glue, a laser weld, or some other type of relatively rigid bond to prevent any residual expansion mismatches in the package and subassembly bases from distorting the package and causing misalignment.

Although this aspect of the present disclosure is merely illustrated with reference to FIG. 15, this manner of isolation via a relatively flexible topographic securement 145 can be incorporated into the other embodiments disclosed herein. In any case where thermal expansion in the optical package would cause the laser and converter bases to expand away from the relatively rigid bond at the bonding interface, since the separation of the respective facets of the laser diode and wavelength conversion device are only a couple of microns, and the relatively flexible topographic securement permits non-disruptive thermal excursions, the resulting movement of these points relative to each other, would merely be on the order of a fraction of a micron along the longitudinal axis of the optical package. In contrast, if the respective facets were to be separated by a few millimeters, the thermal expansion would leads to movement proportional to that separation, i.e., on the order of a few microns, and can lead to the destructive contact of the respective facets of the laser diode and wavelength conversion device.

It is noted that recitations herein of a component of the present disclosure being “configured” in a particular way, to embody a particular property, or function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component. It is also noted that some non-critical structural details of the laser source subassembly, e.g., lead lines, electrical connections, etc., have been omitted from the illustrations presented herewith to preserve clarity but will be readily apparent to those familiar with laser diode design and assembly.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present disclosure it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. An optical package comprising a laser diode chip and a clad metal substrate, wherein:
the clad metal substrate comprises a clad metal region mechanically coupled to a base metal region;
the laser diode chip is mechanically coupled to the clad metal region;
the clad metal region comprises a clad metal material having a thermal conductivity that is greater than a thermal conductivity of the base metal material; and
the clad metal region comprises a coefficient of thermal expansion that is approximately equal to a coefficient of thermal expansion of the base metal material and is greater than a coefficient of thermal expansion of the laser diode chip.

2. The optical package as claimed in claim 1 wherein the laser diode chip is soldered to the clad metal region.

3. The optical package as claimed in claim 1 wherein the laser diode chip is soldered to the clad metal region with a eutectic Au—Sn solder.

4. The optical package as claimed in claim 1 wherein the clad metal region is secured to the base metal region by a cladding process.

5. The optical package as claimed in claim 1 wherein the coefficient of thermal expansion of the clad metal material is such that the laser diode is under compressive stress during a presence of elevated temperatures.

6. The optical package as claimed in claim 1 wherein the thermal conductivity of the clad metal is greater than 80 W/m-k.

7. The optical package as claimed in claim 1 wherein the clad metal material comprises copper, molybdenum, aluminum, or brass.

8. The optical package as claimed in claim 1 wherein the base metal material comprises 304 stainless steel, 304L stainless steel, 410 stainless steel, or bronze.

9. The optical package as claimed in claim 1 wherein the clad metal material comprises copper and the base metal material comprises stainless steel.

10. The optical package as claimed in claim 1 wherein:
the base metal region comprises a first face and a second face that is opposite from the first face; and
the base metal region comprises a mounting slot extending from the first face to the second face of the base metal region, and the clad metal region is mechanically coupled to the base metal region, within the mounting slot.

11. The optical package as claimed in claim 10 wherein a bottom surface of the base metal region comprises a laser base taper angle φ.

12. The optical package as claimed in claim 1 wherein:
the clad metal region comprises an upper clad metal layer and a lower clad metal layer;
the base metal region comprises an inner base metal layer; and
the upper clad metal layer and the lower clad metal layer are positioned above and below the base metal layer, respectively.

13. The optical package as claimed in claim 1 wherein the optical package further comprises a wavelength conversion device coupled to a converter base.

14. The optical package as claimed in claim 13 wherein the base metal region of the clad metal substrate is laser welded to the converter base such that an output beam emitted by the laser diode enters a waveguide input of the wavelength conversion device.

15. The optical package as claimed in claim 13 wherein the respective coefficients of thermal expansion of the converter base and the base metal region are substantially matched so that the relative movement between the laser diode chip and the wavelength conversion device in the vertical direction is limited to approximately 0.5 μm or less over the operating temperature range of the optical package.

16. The optical package as claimed in claim 12 wherein the wavelength conversion device is coupled to the converter base by adhesive bonding.

17. An optical package comprising a laser diode chip, a clad metal substrate, a converter base and a wavelength conversion device, wherein:
the clad metal substrate comprises a clad metal region mechanically coupled to a base metal region;
the base metal region comprises a mounting slot extending from a first face to an opposite second face of the base metal region;
the clad metal is mechanically coupled to the base metal region within the mounting slot;
the laser diode chip is mechanically coupled to the clad metal region;
the clad metal region comprises a clad metal material having a thermal conductivity that is greater than a thermal conductivity of the base metal material;
the clad metal region comprises a coefficient of thermal expansion that is approximately equal to a coefficient of thermal expansion of the base metal material and is greater than a coefficient of thermal expansion of the laser diode chip such that the laser diode is under compressive stress during a presence of elevated temperatures;
the wavelength conversion device is coupled to the converter base; and
the base metal region of the clad metal substrate is laser welded to the converter base.

18. The optical package as claimed in claim 17 wherein the clad metal material comprises copper and the base metal material comprises 304L stainless steel.
